(19) United States
(12) Patent Application Publication
(10) Pub. No.: US 2020/0256566 A1
(43) Pub. Date: Aug. 13, 2020

(54) HOT WATER SUPPLY SYSTEM

(71) Applicant: LIXIL Corporation, Tokyo (JP)

(72) Inventor: Satoshi YOSHIDA, Tokyo (JP)

(73) Assignee: LIXIL Corporation, Tokyo (JP)

(21) Appl. No.: 16/651,957

(22) PCT Filed: May 1, 2018
(86) PCT No.: PCT/JP2018/017411

§ 371 Date: Mar. 27, 2020

(30) Foreign Application Priority Data
Sep. 28, 2017 (JP) 2017-187764

(51) Int. Cl. F24D 17/00; G05D 23/13; E03C 1/02

(52) U.S. Cl. CPC F24D 17/0005; G05D 23/1353; E03C 2001/005; E03C 1/02; F24D 17/0026

(57) ABSTRACT

A hot water supply system includes a water supply pipe for supplying cold water, a hot water supply pipe for supplying hot water heated by a hot water supply device, a drain pipe for draining waste water, a heat exchange device for heating cold water supplied from the water supply pipe using the waste water, and a flow rate control mechanism for controlling, when supplying warm water obtained by mixing cold water heated by the heat exchange device and hot water heated by the hot water supply device, the flow rate of the cold water and the flow rate of the hot water so as to maintain the temperature of the warm water.

### CROSS-REFERENCE TO RELATED APPLICATIONS

This application is a national stage application under 35 USC 371 of International Application No. PCT/JP2018/017411, filed May 1, 2018, which claims the priority of Japanese Application No. 2017-187764, filed Sep. 28, 2017, the entire contents of each of which are incorporated herein by reference.

### FIELD OF THE DISCLOSURE

The present invention relates to a hot water supply technology, and more particularly, to a hot water supply system that can reuse the heat of waste water.

### BACKGROUND OF THE DISCLOSURE

Currently, under the initiative of the government, efforts are being made to disseminate net zero energy houses (ZEH). ZEH stands for “a house that aims to make the annual primary energy consumption balance to be zero by introducing renewable energy after greatly improving the heat insulation performance and the like of the outer skin and realizing significant energy savings while maintaining the quality of the indoor environment through the introduction of highly efficient equipment systems”. The Ministry of Economy, Trade and Industry has set a goal of “realizing ZEH in a majority of custom-built detached houses built by house makers, etc., by 2020”, and various technologies for realizing ZEH are being developed by house makers, etc.

As a technique for realizing energy saving in houses, there is a technique of reusing waste heat (for example, see Patent Document 1). A hot water supply device described in Patent Document 1 includes a hot water supply pipe that supplies water from a water supply source such as waterworks and a water supply pipe that supplies water from the water supply source without passing through a water boiler and is configured to supply hot water from the hot water supply pipe and water from the water supply pipe while mixing water through a mixing faucet or without mixing. A waste heat recovery unit for heat exchange and recovery of already-used hot waste water is provided in the hot water supply pipe or in the water supply pipe, and water passing through the waste heat recovery unit is supplied to the mixing faucet via the hot water supply pipe or the water supply pipe.

Patent Document 1 Japanese Registered Utility Model No. 3149968

### SUMMARY OF THE DISCLOSURE

In the hot water supply device described in Patent Document 1, there is a problem that since the temperature of the water that has passed through the waste heat recovery unit can change every moment according to the temperature and amount of the hot waste water, the temperature of the hot water discharged from the mixing faucet can also change every moment.

In this background, a purpose of the present invention is to provide a highly convenient hot water supply system capable of reducing energy consumption by reusing the heat of waste water.

A hot water supply system according to some embodiments of the present invention includes a water supply pipe for supplying cold water, a hot water supply pipe for supplying hot water heated by a hot water supply device, a drain pipe for draining waste water, a heat exchange device for heating cold water supplied from the water supply pipe using the waste water, and a flow control mechanism for controlling, when supplying warm water obtained by mixing cold water heated by the heat exchange device and hot water heated by the hot water supply device, the flow rate of the cold water and the flow rate of the hot water so as to maintain the temperature of the warm water.

In some embodiments, since the heat of the waste water can be efficiently reused, energy consumption can be reduced. Further, since the temperature of warm water that is discharged is automatically kept constant, the convenience for the user can be improved.

The flow control mechanism may be a thermostatic faucet. In some embodiments, the cost for installing this hot water supply system can be reduced. Further, this hot water supply system can be installed in an existing house without requiring a large capital investment.

When the temperature difference between the cold water and the hot water is smaller than a predetermined value, the hot water supply device may be instructed to increase the temperature of the hot water. In some embodiments, when a thermostatic faucet is used as the flow rate control mechanism, the flow rate of the hot water can be reduced, and energy consumption can thus be reduced.

The flow rate control mechanism may include a valve that is provided in the water supply pipe or the hot water supply pipe and whose opening and closing are electrically controllable, and a valve control unit for controlling the valve. In some embodiments, a control valve opening position can be designed such that more cold water heated by the heat of the waste water can be used while allowing warm water obtained by mixing hot water and cold water to have a required temperature, and energy consumption can thus be reduced.

The heat exchange device may be a plate type heat exchanger. In some embodiments, since the heat exchange efficiency in the heat exchange device can be increased, energy consumption can be reduced.

Overflow piping for draining waste water overflowing from the heat exchange device without letting the waste water pass through the heat exchange device may be provided to the drain pipe upstream of the heat exchange device. In some embodiments, even when a large amount of waste water is drained when using a heat exchange device with high heat exchange efficiency and a large pipe resistance, overflowing waste water can be properly drained to a sewage system or the like.

Washing water piping for supplying water for washing the heat exchange device to the heat exchange device may be provided to the drain pipe upstream of the heat exchange device. In some embodiments, it is possible to prevent the waste water from staying inside the heat exchange device and thus suppress the dirt and clogging of the piping of the heat exchange device.

A cross connection prevention mechanism may be provided between the washing water piping and the drain pipe. In some embodiments, it is possible to properly prevent clean water from being contaminated by the waste water.

In some embodiments, a highly convenient hot water supply system capable of reducing energy consumption can be provided.

### BRIEF DESCRIPTION OF THE FIGURES

FIG. 1 is a diagram schematically showing the configuration of a hot water supply system, according to some embodiments;

FIG. 2 is a diagram schematically showing the structure of a thermostatic faucet which is an example of a flow rate control mechanism, according to some embodiments;

FIG. 3 is a diagram showing the configuration of a flow rate control mechanism using the thermostatic faucet, according to some embodiments;

FIG. 4 is a diagram showing a configuration for controlling an electromagnetic valve which is another example of the flow rate control mechanism, according to some embodiments;

FIGS. 5A and 5B are diagrams showing experimental results when a plate type heat exchanger and a multi-tube heat exchanger are used as heat exchange devices, according to some embodiments; and

FIG. 6 is a diagram schematically showing the configuration of piping for introducing waste water into a heat exchange device, according to some embodiments.

### DETAILED DESCRIPTION OF THE DISCLOSURE

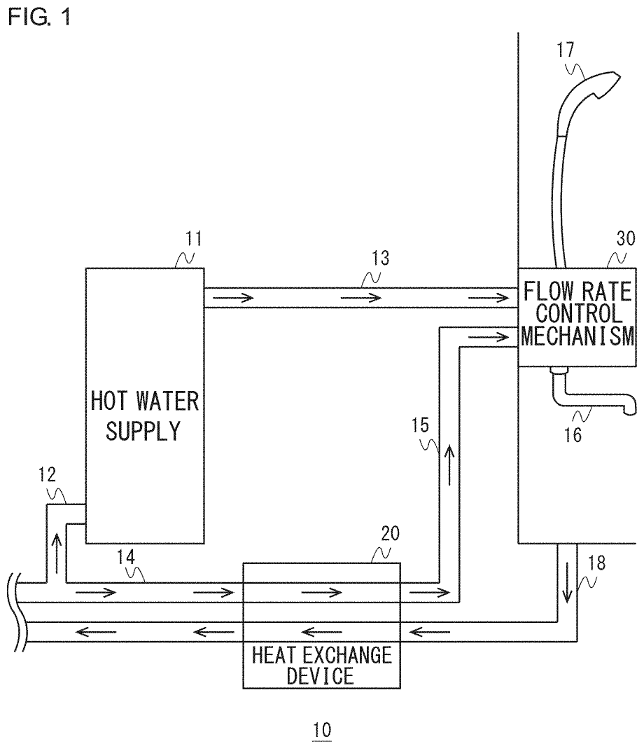

FIG. 1 schematically shows the configuration of a hot water supply system according to an embodiment. A hot water supply system 10 includes water supply pipes 12 and 14 for supplying cold water, a hot water supply pipe 13 for supplying hot water heated by a hot water supply device 11, a drain pipe 18 for draining waste water, a heat exchange device 20 for heating cold water supplied from the water supply pipe 14 using the waste water, and a flow rate control mechanism 30 for controlling, when supplying warm water obtained by mixing cold water heated by the heat exchange device 20 and hot water heated by the hot water supply device 11, the flow rate of the cold water and the flow rate of the hot water so as to maintain the temperature of the warm water. The warm water supplied while being maintained at a constant temperature by the flow rate control mechanism 30 is discharged from, for example, a faucet 16 or a shower 17 installed in a bathroom and used by a user.

When the user is using the faucet 16, the shower 17, or the like, the temperature of warm water that is discharged hardly drops, that is, the heat of the warm water is hardly used, and the warm water is drained from a drain port installed in a bathroom or the like. Therefore, in the hot water supply system 10 according to some embodiments, waste water that is drained while still being warm is introduced into the heat exchange device 20 and used to heat water supplied to the faucet 16, the shower 17, or the like that is being used. Thereby, the temperature of cold water that is mixed with hot water can be raised, and the amount of hot water required to maintain the temperature of warm water that is discharged can be reduced, allowing the energy consumption to be reduced.

As described above, the temperature of cold water that is heated by the heat of the waste water in the heat exchange device 20 and that is supplied from the water supply pipe 15 can change according to the temperature and amount of the waste water. In the hot water supply system 10 according to some embodiments, since the flow rate control mechanism 30 automatically controls the flow rate of cold water and the flow rate of hot water so as to maintain the temperature of warm water to be constant, warm water having a stable temperature is discharged from the faucet 16 and the shower 17. Thereby, the convenience of the user can be improved, and the spread of hot water supply systems 10 that can reduce energy consumption can be promoted consequently.

The flow rate control mechanism 30 may be any mechanism that can automatically control the flow rate of cold water or hot water and may also be a mechanism that mechanically or electrically controls the flow rate. As a mechanism for mechanically controlling the flow rate, for example, a thermostatic faucet may be used. Further, as a mechanism for electrically controlling the flow rate, for example, a valve such as an electromagnetic valve or an electric valve that can automatically control opening and closing may be used.

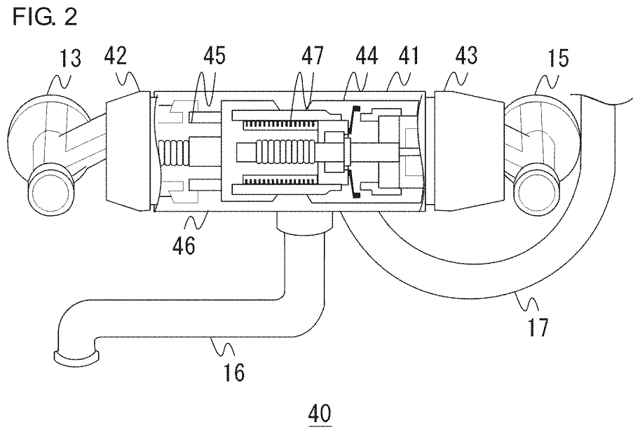

FIG. 2 schematically shows the structure of a thermostatic faucet which is an example of a flow rate control mechanism. In the hot water supply system 10 according to some embodiments, an existing general thermostatic faucet 40 can be used. The thermostatic faucet 40 includes a tubular faucet main body 41, a temperature adjustment handle 42, a flow rate adjustment handle 43, a water chamber 44 into which cold water supplied from the water supply pipe 15 flows, a hot water chamber 45 into which hot water supplied from the hot water supply pipe 13 flows, a mixing chamber 46 in which the cold water flowing into the water chamber 44 and the hot water flowing into the hot water chamber 45 are mixed, and a valve 47 formed of a thermosensitive expander that expands and contracts according to a change in the temperature and of a spring. The valve 47 moves due to the expansion and contraction of the thermosensitive expander according to the temperature of the cold water flowing into the water chamber 44 and the temperature of the hot water flowing into the hot water chamber 45, and the opening area ratio of an inflow port for the cold water and an inflow port for the hot water changes. Thereby, the flow rate of the cold water and the flow rate of the hot water are automatically adjusted such that warm water having the temperature set by the temperature adjustment handle 42 is obtained. As described above, by using the thermostatic faucet 40, even when the temperature of the cold water supplied from the water supply pipe 15 changes, the flow rate of the hot water and the flow rate of the cold water are automatically adjusted, and the temperature of the warm water that is discharged can be kept constant. In addition, the cost for installing a hot water supply system 10 according to some embodiments can be reduced. Further, a hot water supply system 10 according to some embodiments can be installed in an existing house or the like without requiring a large capital investment.

The present inventors have conducted experiments to see how the flow rate of hot water supplied from the hot water supply pipe 13 changes when the temperature of cold water supplied from the water supply pipe 15 rises in the hot water supply system 10 using the thermostatic faucet 40 as the flow rate control mechanism 30. The experimental conditions are as follows. In either of the experiments, the temperature of warm water to be discharged was set to 40° C. by the temperature adjustment handle 42, and the flow rate of the warm water to be discharged was set to 10 L/min by the flow rate adjustment handle 43.

Experiment 1 The preset temperature of the hot water supply device 11 was set to 40° C., and the temperature of cold water supplied from the water supply pipe 15 was changed from 20° C. to 40° C. while supplying hot water of 40° C. from the hot water supply pipe 13.

Experiment 2 The preset temperature of the hot water supply device 11 was set to 50° C., and the temperature of cold water supplied from the water supply pipe 15 was changed from 20° C. to 40° C. while supplying hot water of 50° C. from the hot water supply pipe 13.

In either of the experiments, since warm water of 40° C. that is set can be discharged without mixing hot water supplied from the hot water supply pipe 13 when the temperature of cold water supplied from the water supply pipe 15 rises to 40° C., the flow rate of the hot water can be ideally reduced to zero. However, although the flow rate of hot water was reduced by about 45% in Experiment 2, the flow rate of hot water was reduced by only about 21% in Experiment 1. The inventors of the present invention consider that this is due to the opening area ratio of the inflow port of cold water and the inflow port of hot water not having changed so much since the temperature of the supplied hot water and the temperature of the supplied cold water were almost the same as the temperature of the warm water to be discharged and the position of the valve 47 moved by the thermosensitive expander thus did not move as much as expected in Experiment 1. As shown by Experiment 2, when the preset temperature of the hot water supply device 11 is set to 50° C. and hot water of 50° C. is supplied from the hot water supply pipe 13, the effect of reducing the consumption of hot water can be expected by heating cold water supplied from the water supply pipe 15.

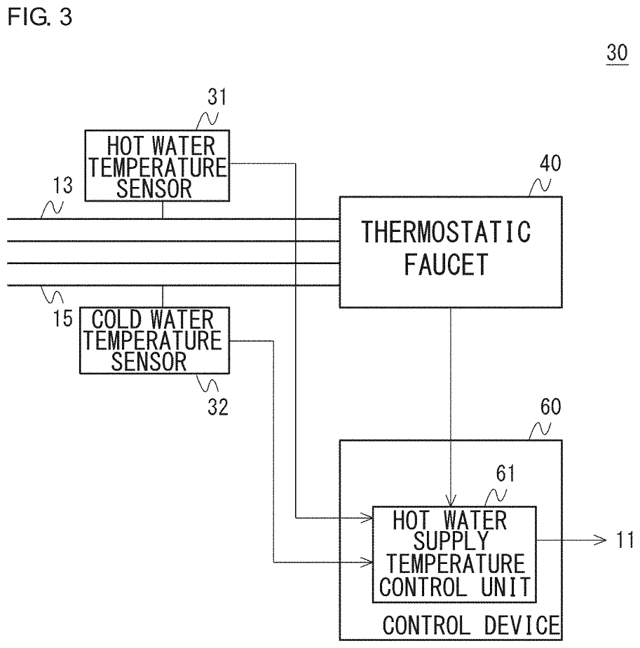

FIG. 3 shows the configuration of a flow rate control mechanism using a thermostatic faucet. The flow rate control mechanism 30 includes a thermostatic faucet 40, a hot water temperature sensor 31 for detecting the temperature of hot water supplied from the hot water supply pipe 13, a cold water temperature sensor 32 for detecting the temperature of cold water supplied from the water supply pipe 15, and a hot water supply temperature control unit 61 for controlling the preset temperature of the hot water supply device 11. The hot water supply temperature control unit 61 is provided in a control device 60 such as a microcomputer. The hot water supply temperature control unit 61 acquires and compares the temperature of hot water detected by the hot water temperature sensor 31 and the temperature of cold water detected by the cold water temperature sensor 32. When the temperature difference between the cold water and the hot water is smaller than a predetermined value, the hot water supply temperature control unit 61 instructs the hot water supply device 11 to increase the hot water supply temperature. The hot water supply temperature control unit 61 may instruct the hot water supply device 11 to change the preset temperature of the hot water supply device 11 to a temperature that is sufficiently higher than the preset temperature set in the thermostatic faucet 40, for example, to 45° C. to 50° C. Thereby, since the flow rate of the hot water when heated cold water is supplied from the water supply pipe 15 can be reduced, the energy consumption can be reduced. The hot water supply temperature control unit 61 may change the preset temperature of the hot water supply device 11 that has been changed to a higher temperature back to the original temperature when a predetermined amount of time has elapsed after warm water is no longer discharged from thermostatic faucet 40. Thereby, while the thermostatic faucet 40 is not being used, the preset temperature of the hot water supply device 11 can be lowered so as to suppress heat loss in the piping. Thus, energy consumption can be reduced.

The hot water supply temperature control unit 61 may acquire the preset temperature set by the temperature adjustment handle 42 of the thermostatic faucet 40 and the hot water supply temperature set by the hot water supply device 11 and instruct the hot water supply device 11 to increase the hot water supply temperature when the temperature difference between the two is smaller than a predetermined value. Also with this, since the flow rate of the hot water when the heated cold water is supplied from the water supply pipe 15 can be reduced, the energy consumption can be reduced. In this case, the hot water temperature sensor 31 and the cold water temperature sensor 32 may not be provided.

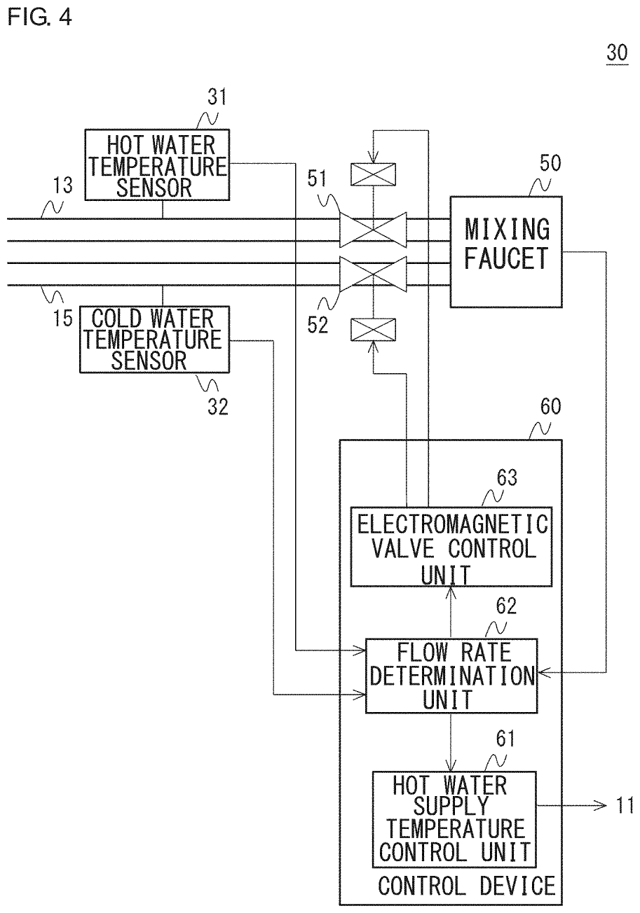

FIG. 4 shows a configuration for controlling an electromagnetic valve which is another example of the flow rate control mechanism. The flow rate control mechanism 30 includes a mixing faucet 50, a hot water temperature sensor 31 for detecting the temperature of hot water supplied from the hot water supply pipe 13, a cold water temperature sensor 32 for detecting the temperature of cold water supplied from the water supply pipe 15, a hot water supply pipe electromagnetic valve 51 for controlling the flow rate of the hot water supplied from the hot water supply pipe 13, a water supply pipe electromagnetic valve 52 for controlling the flow rate of the cold water supplied from the water supply pipe 15, a flow rate determination unit 62 for determining the flow rate of the hot water and the flow rate of the cold water, an electromagnetic valve control unit 63 for controlling the opening and closing of the hot water supply pipe electromagnetic valve 51 and the water supply pipe electromagnetic valve 52, and a hot water supply temperature control unit 61 for controlling the preset temperature of the hot water supply device 11. The hot water supply temperature control unit 61, the flow rate determination unit 62, and the electromagnetic valve control unit 63 are provided in a control device 60 such as a microcomputer.

In accordance with the temperature and flow rate of discharged water set for the mixing faucet 50, the temperature of hot water detected by the hot water temperature sensor 31, and the temperature of cold water detected by the cold water temperature sensor 32, the flow rate determination unit 62 determines the flow rate of hot water and the flow rate of cold water to be allowed to flow into the mixing faucet 50 and notifies the electromagnetic valve control unit 63 of the flow rates. The electromagnetic valve control unit 63 controls the opening and closing of the hot water supply pipe electromagnetic valve 51 and the water supply pipe electromagnetic valve 52 so as to achieve the flow rates determined by the flow rate determination unit 62. This allows the flow rate of cold water or hot water to be controlled in a more detailed manner. Thus, by designing a control valve opening position such that more cold water heated by the heat of the waste water can be used while allowing warm water obtained by mixing hot water and cold water to have a required temperature, energy consumption can be reduced. Further, since the temperature of warm water that is discharged can be controlled in a more detailed manner, the convenience for the user can be improved.

The hot water supply temperature control unit 61 controls the preset temperature of the hot water supply device 11. In this example, it is not necessary to control the hot water supply temperature in order to adjust the operation state of a thermostat. However, for example, when the temperature of cold water supplied from the water supply pipe 15 is heated to a temperature close to the temperature set for the mixing faucet 50, the hot water supply temperature control unit 61 may instruct the hot water supply device 11 to lower the preset temperature of the hot water supply device 11 to around the temperature set for the mixing faucet 50. Thereby, energy consumption in the hot water supply device 11 can be reduced.

As the heat exchange device 20 used in the hot water supply system 10 according to some embodiments, an existing general heat exchanger such as a plate type heat exchanger, a multi-pipe heat exchanger, and a double-pipe heat exchanger can be used. In order to reduce the energy consumption, it is desirable to use a heat exchanger with a high heat recovery rate. However, in order to allow the heat of waste water during the use of the shower 17 or the like to be recovered and reused for the shower 17 on the spot, a high reaction rate is also required.

The inventors of the present invention introduced waste water and tap water of about 18° C. into the heat exchange device 20 when warm water of 40° C. was discharged from the shower 17 at 6.5 L/min and measured the heat exchange capacity, the reaction speed, and the heat recovery rate in the hot water supply system 10 using a plate type heat exchanger and a multi-pipe heat exchanger as the heat exchange device 20.

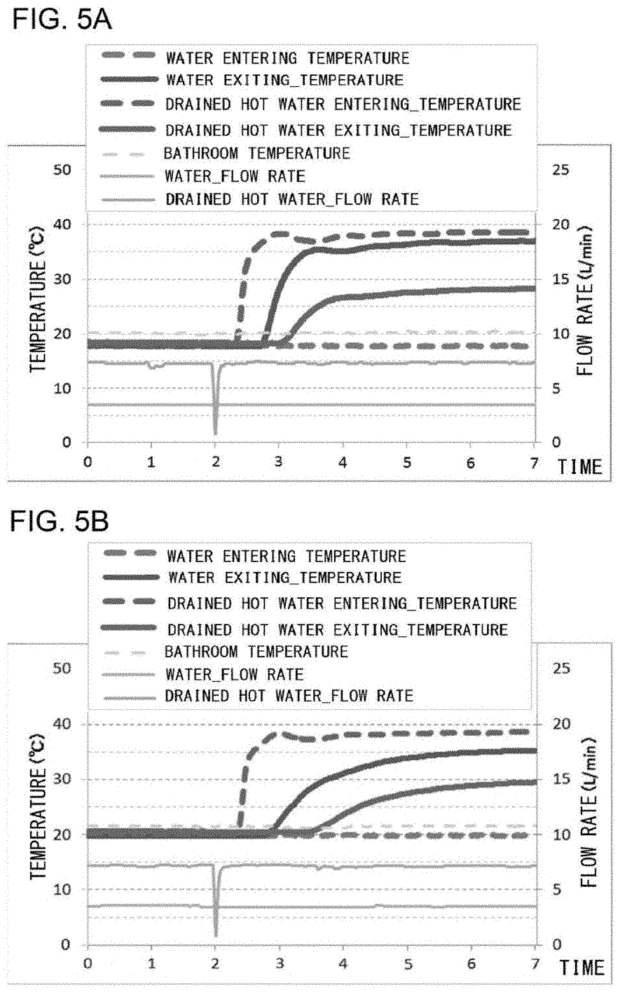

FIG. 5A is a diagram showing the experimental result when a plate type heat exchanger was used as the heat exchange device. The time required from when warm water started being discharged by the shower 17 until the temperature of the water at the outlet of the heat exchange device 20 exceeded 30° C. was about 45 seconds. The heat exchange capacity was about 44% as an instantaneous value in an equilibrium state, and the heat recovery rate was about 38% as an integrated value for 5 minutes. FIG. 5B shows the experimental result when a multi-pipe heat exchanger was used as the heat exchange device. The time required from when warm water started being discharged by the shower 17 until the temperature of the water at the outlet of the heat exchange device 20 exceeded 30° C. was about 105 seconds. The heat exchange capacity was about 41% as an instantaneous value in an equilibrium state, and the heat recovery rate was about 30% as an integrated value for 5 minutes.

It was found that the heat exchange capacity and the heat recovery rate were sufficiently high and the time required for heating was sufficiently short in the case when the plate type heat exchanger was used and in the case when the multi-pipe heat exchanger was used. Therefore, in a case when warm water is discharged continuously for about several minutes such as when using warm water to take a shower 17 in a bathroom, using warm water to wash a face in a washroom, or using warm water to wash dishes or the like in a kitchen, the heat of waste water after use can be immediately recovered and reused for hot water supply. Therefore, the heat of the waste water can be efficiently reused, and the energy consumption can thus be reduced. When a plate type heat exchanger is used, since particularly the heat exchange capacity, the heat recovery rate, and the reaction speed can be increased, the energy consumption can therefore be further reduced.

In general, since a heat exchanger with a high heat recovery rate has a high pipe resistance, overflow may occur when a large amount of waste water is drained. Therefore, when a heat exchanger having a high pipe resistance is used as the heat exchange device 20 of the hot water supply system 10 according to some embodiments, overflow piping for draining waste water overflowing from the heat exchange device 20 without letting the waste water pass through the heat exchange device 20 may be provided to the drain pipe 18 upstream of the heat exchange device 20.

Also, since waste water is introduced into the heat exchange device 20, the waste water and dirt and scum of detergent, soap, shampoo, and the like contained in the waste water in the heat exchange device 20 may cause dirt and clogging of the piping. Therefore, in the hot water supply system 10 according to some embodiments, washing water piping for supplying water for washing the heat exchange device 20 to the heat exchange device 20 may be provided to the drain pipe 18 upstream of the heat exchange device 20.

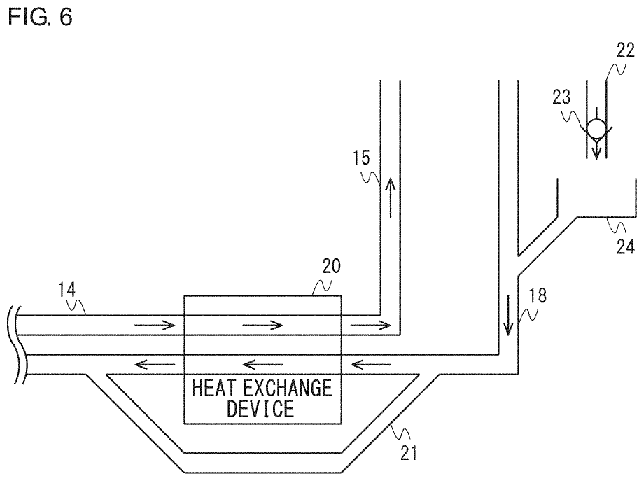

FIG. 6 schematically shows the configuration of piping for introducing waste water into the heat exchange device 20. Overflow piping 21 for draining waste water overflowing from the heat exchange device 20 without letting the waste water passing through the heat exchange device 20 is provided to the drain pipe 18 upstream of the heat exchange device 20. Thereby, when a heat exchanger having a high heat exchange efficiency and a large pipe resistance such as a plate type heat exchanger is used as the heat exchange device 20, even if a large amount of waste water is drained at once, overflowing waste water can be properly drained to a sewage system or the like. In a bathroom of a standard house, often times piping for draining water discharged from the faucet 16, the shower 17, or the like and piping for draining water stored in the bathtub are shared. When introducing waste water to the heat exchange device 20 only from the piping for draining water discharged from the faucet 16, the shower 17, or the like, there is a low possibility that a large amount of waste water is drained all at a time, and the overflow piping 21 may not be provided.

An electromagnetic valve controlled by the control device 60 may be provided in the overflow piping 21. Further, the drain pipe 18 may be provided with a flow rate sensor for detecting the flow rate of waste water. In this case, the electromagnetic valve may be opened upon detection of the draining of a large amount of waste water all at a time such as when water stored in the bathtub is drained, and the electromagnetic valve may be closed otherwise. Further, the drain pipe 18 may be provided with a waste water sensor for detecting the temperature of waste water. In this case, when the temperature of the waste water is higher than a predetermined value, the electromagnetic valve of the overflow piping 21 is closed, and the waste water is introduced into the heat exchange device 20 in order to reuse the heat of the waste water. When the temperature of the waste water is lower than the predetermined value, the electromagnetic valve of the overflow piping 21 may be opened so as to drain the waste water from the overflow piping 21.

Washing water piping 22 for supplying water for washing the heat exchange device 20 to the heat exchange device 20 is further provided to the drain pipe 18 upstream of the heat exchange device 20. Thereby, it is possible to prevent the waste water and the dirt and scum of detergent, soap, shampoo, and the like contained in the waste water from staying inside the heat exchange device 20 and thus suppress the dirt and clogging of the piping of the heat exchange device 20. A check valve 23 and a water discharge port space 24 are provided between the washing water piping 22 and the drain pipe 18 as a cross connection prevention mechanism. Thereby, it is possible to properly prevent waste water passing through the drain pipe 18 from flowing back to the washing water piping 22 and contaminating the clean water. The washing water piping 22 is desirably connected to the drain pipe 18 on the upstream side of the overflow piping 21. Thereby, even if waste water overflows from the heat exchange device 20, it is possible to prevent the waste water from flowing back to the washing water piping 22. Piping having a large inner diameter is desirably used as the overflow piping 21, and for example, piping of 50 φ may be used.

The following technical ideas are derived by generalizing the invention embodied according to some embodiments and exemplary variations.

A hot water supply system according to some embodiments of the present invention includes a water supply pipe for supplying cold water, a hot water supply pipe for supplying hot water heated by a hot water supply device, a drain pipe for draining waste water, a heat exchange device for heating cold water supplied from the water supply pipe using the waste water, and a flow rate control mechanism for controlling, when supplying warm water obtained by mixing cold water heated by the heat exchange device and hot water heated by the hot water supply device, the flow rate of the cold water and the flow rate of the hot water so as to maintain the temperature of the warm water.

According to some embodiments, since the heat of the waste water can be efficiently reused, energy consumption can be reduced. Further, since the temperature of warm water that is discharged is automatically kept constant, the convenience for the user can be improved.

The flow rate control mechanism may be a thermostatic faucet. According to some embodiments, the cost for installing this hot water supply system can be reduced. Further, this hot water supply system can be installed in an existing house without requiring a large capital investment.

When the temperature difference between the cold water and the hot water is smaller than a predetermined value, the hot water supply device may be controlled so as to increase the temperature of the hot water. According to some embodiments, when a thermostatic faucet is used as the flow rate control mechanism, the flow rate of the hot water can be reduced, and energy consumption can thus be reduced.

The flow rate control mechanism may include a valve that is provided in the water supply pipe or the hot water supply pipe and whose opening and closing are electrically controllable, and a valve control unit for controlling the valve. According to some embodiments, a control valve opening position can be designed such that more cold water heated by the heat of the waste water can be used while allowing warm water obtained by mixing hot water and cold water to have a required temperature, and energy consumption can thus be reduced.

The heat exchange device may be a plate type heat exchanger. According to some embodiments, since the heat exchange capacity, the heat recovery rate, and the reaction speed in the heat exchange device can be increased, energy consumption can be reduced.

Overflow piping for draining waste water overflowing from the heat exchange device without letting the waste water pass through the heat exchange device may be provided to the drain pipe upstream of the heat exchange device. According to some embodiments, even when a large amount of waste water is drained when using a heat exchange device with high heat exchange capacity, a high heat recovery rate, and a large pipe resistance, overflowing waste water can be properly drained to a sewage system or the like.

Washing water piping for supplying water for washing the heat exchange device to the heat exchange device may be provided to the drain pipe upstream of the heat exchange device. According to some embodiments, it is possible to prevent the waste water and the dirt and scum of detergent, soap, shampoo, and the like contained in the waste water from staying inside the heat exchange device and thus suppress the dirt and clogging of the piping of the heat exchange device.

A cross connection prevention mechanism may be provided between the washing water piping and the drain pipe. According to some embodiments, it is possible to properly prevent clean water from being contaminated by the waste water.

While the present invention has been described based on some embodiments, these embodiments are merely illustrative of the principles and applications of the present invention. Additionally, many variations and changes in arrangement may be made in the embodiments without departing from the spirit of the present invention as defined by the appended claims.

Embodiments in which warm water is used in a bathroom has been mainly described. However, the hot water supply system according to these embodiments are applicable to any facility where warm water is used such as a kitchen or a washroom. Further, waste water from a plurality of facilities may be introducible into the heat exchange device. Thereby, for example, when washing dishes using warm water in the kitchen, the heat of waste water in the kitchen can be reused to heat cold water to be put in the bathtub. Thereby, the energy consumed in the house can be further reduced.

1. A hot water supply system comprising:
a water supply pipe for supplying cold water;
a hot water supply pipe for supplying hot water heated by a hot water supply device;
a drain pipe for draining waste water;
a heat exchange device for heating cold water supplied from the water supply pipe using the waste water; and
a flow rate control mechanism for controlling, when supplying warm water obtained by mixing cold water heated by the heat exchange device and hot water heated by the hot water supply device, the flow rate of the cold water and the flow rate of the hot water so as to maintain the temperature of the warm water.

2. The hot water supply system of claim 1, wherein the flow rate control mechanism is a thermostatic faucet.

3. The hot water supply system of claim 2, wherein the hot water supply system controls the hot water supply device so as to increase the temperature of the hot water when the temperature difference between the cold water and the hot water is smaller than a predetermined value.

4. The hot water supply system of claim 1, wherein the flow rate control mechanism comprises:
a valve that is provided in the water supply pipe or the hot water supply pipe and whose opening and closing are electrically controllable; and
a valve control unit for controlling the valve.

5. The hot water supply system of claim 1, wherein the heat exchange device is a plate type heat exchanger.

6. The hot water supply system of claim 1, wherein overflow piping for draining waste water overflowing from the heat exchange device without letting the waste water pass through the heat exchange device is provided to the drain pipe upstream of the heat exchange device.

7. The hot water supply system of claim 1, wherein washing water piping for supplying water for washing the heat exchange device to the heat exchange device is provided to the drain pipe upstream of the heat exchange device.

8. The hot water supply system of claim 7, wherein a cross connection prevention mechanism is provided between the washing water piping and the drain pipe.

9. The hot water supply system of claim 2, wherein the heat exchange device is a plate type heat exchanger.

10. The hot water supply system of claim 3, wherein the heat exchange device is a plate type heat exchanger.

11. The hot water supply system of claim 2, wherein overflow piping for draining waste water overflowing from the heat exchange device without letting the waste water pass through the heat exchange device is provided to the drain pipe upstream of the heat exchange device.

12. The hot water supply system of claim 3, wherein overflow piping for draining waste water overflowing from the heat exchange device without letting the waste water pass through the heat exchange device is provided to the drain pipe upstream of the heat exchange device.

13. The hot water supply system of claim 4, wherein overflow piping for draining waste water overflowing from the heat exchange device without letting the waste water pass through the heat exchange device is provided to the drain pipe upstream of the heat exchange device.

14. The hot water supply system of claim 5, wherein overflow piping for draining waste water overflowing from the heat exchange device without letting the waste water pass through the heat exchange device is provided to the drain pipe upstream of the heat exchange device.

15. The hot water supply system of claim 9, wherein overflow piping for draining waste water overflowing from the heat exchange device without letting the waste water pass through the heat exchange device is provided to the drain pipe upstream of the heat exchange device.

16. The hot water supply system of claim 10, wherein overflow piping for draining waste water overflowing from the heat exchange device without letting the waste water pass through the heat exchange device is provided to the drain pipe upstream of the heat exchange device.

17. The hot water supply system of claim 5, wherein washing water piping for supplying water for washing the heat exchange device to the heat exchange device is provided to the drain pipe upstream of the heat exchange device.

18. The hot water supply system of claim 6, wherein washing water piping for supplying water for washing the heat exchange device to the heat exchange device is provided to the drain pipe upstream of the heat exchange device.

19. The hot water supply system of claim 17, wherein a cross connection prevention mechanism is provided between the washing water piping and the drain pipe.

20. The hot water supply system of claim 18, wherein a cross connection prevention mechanism is provided between the washing water piping and the drain pipe.
